(19) United States
(12) Patent Application Publication
(10) Pub. No.: US 2010/0249969 A1
(43) Pub. Date: Sep. 30, 2010

(54) Work Content Variation Control System

(75) Inventors: Jason T. Durst, Round Rock, TX (US); James K. Gruwell, Liberty Hill, TX (US); Jose L. Martinez, Round Rock, TX (US)

Correspondence Address: HAYNES AND BOONE, LLP;IP Section, 2323 Victory Avenue, Suite 700, Dallas, TX, 75219, US

(73) Assignee: Dell Products L.P., Round Rock, TX (US)

(21) Appl. No.: 12/412,089

(22) Filed: Mar. 26, 2009

(51) Int. Cl. G06F 17/00; G06N 5/02

(52) U.S. Cl. 700/100; 706/47

(57) ABSTRACT

A work content variation control system includes an apparatus having a computer-readable medium encoded with a computer program. The computer program, when executed, receives order data for a family grouping of a plurality of ordered products, converts the order data to work content, groups the order data with like order data with respect to the work content, creates parsing rules with respect to the work content and defines setup rules for use to schedule assembly of the ordered products.

### BACKGROUND

The present disclosure relates generally to information handling systems, and more particularly to a work content variation control system.

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

IHSs are typically assembled in an assembly line where parts are added and software is installed in a process that begins with a number of part and ends with a finished product. In an effort to significantly reduce manufacturing costs in a highly configurable build to order environment (e.g., in an IHS build to order environment), a progressive assembly line (e.g., lean lines) may be implemented in the manufacturing facility. Traditionally, an assembly line works best in a low work content variation environment. This may be due to the fact that high work content variation results in assembly line inefficiencies because the slowest assembly station in the assembly line may shift each time a different configuration is assembled. In other words, the production line is as fast as the slowest station and as the configuration changes, the slowest portion of the assembly time or the bottleneck, may move from one station to another station because different parts or different numbers of parts are being assembled at a given station.

As such, what is needed is work content variation control system to develop rules that production control can use to schedule factory assembly, while minimizing work content variation in the lean lines. The system may minimize work content variation at the platform level within a setup which results in better assembly line efficiencies, improved flow throughout the manufacturing factory and a better rate predictability per setup.

Accordingly, it would be desirable to provide an improved work content variation control system absent the disadvantages discussed above.

### SUMMARY

According to one embodiment, a work content variation control system includes an apparatus having a computer-readable medium encoded with a computer program. The computer program, when executed, receives order data for a family grouping of a plurality of ordered products, converts the order data to work content, groups the order data with like order data with respect to the work content, creates parsing rules with respect to the work content and defines setup rules for use to schedule assembly of the ordered products.

### BRIEF DESCRIPTION OF THE DRAWINGS

FIG. 1 illustrates a block diagram of an embodiment of an information handling system (IHS).

FIG. 2 illustrates an embodiment of a graph showing % of volume vs. configurations sorted by work content and work content time used in an embodiment of a work content variation control system.

FIG. 3 illustrates a high-level flow chart of an embodiment of a method for work content variation control.

FIG. 4 illustrates a detailed flow chart of an embodiment of a method for work content variation control.

FIG. 5 a illustrates a chart showing embodiments of different parsing rules for use in the methods provided in FIGS. 3 and 4.

FIG. 6 illustrates embodiment of three balanced bar charts showing work content at each of a number of work stations along an assembly line.

### DETAILED DESCRIPTION

For purposes of this disclosure, an IHS 100 includes any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an IHS 100 may be a personal computer, a network storage device, or any other suitable device and may vary in size, shape, performance, functionality, and price. The IHS 100 may include random access memory (RAM), one or more processing resources such as a central processing unit (CPU) or hardware or software control logic, read only memory (ROM), and/or other types of nonvolatile memory. Additional components of the IHS 100 may include one or more disk drives, one or more network ports for communicating with external devices as well as various input and output (I/O) devices, such as a keyboard, a mouse, and a video display. The IHS 100 may also include one or more buses operable to transmit communications between the various hardware components.

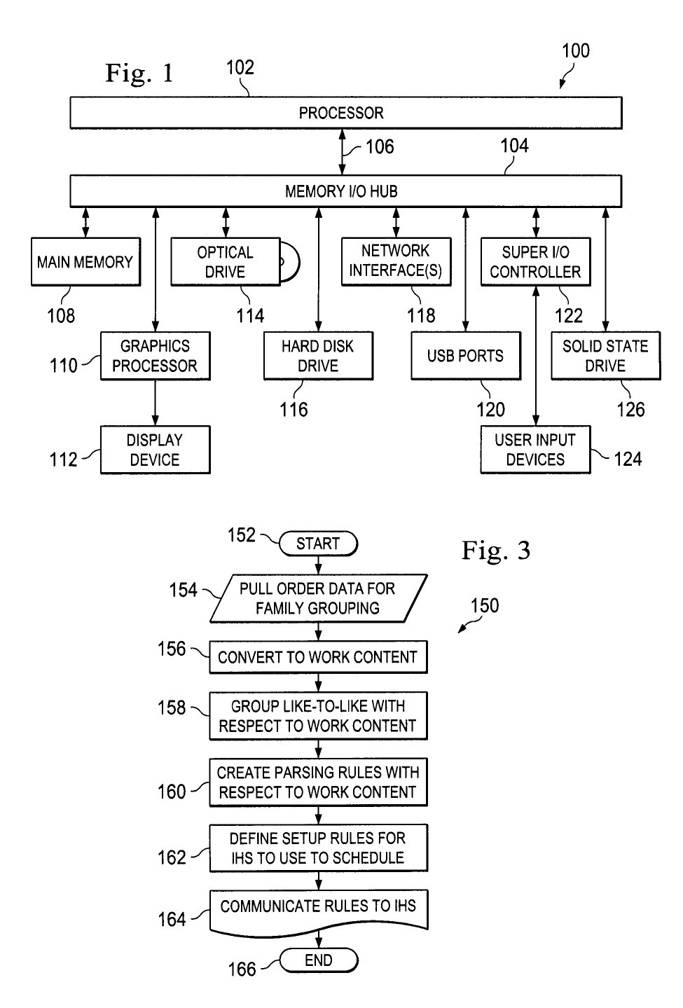

FIG. 1 is a block diagram of one IHS 100. The IHS 100 includes a processor 102 such as an Intel Pentium™ series processor or any other processor available. A memory I/O hub chipset 104 (comprising one or more integrated circuits) connects to processor 102 over a front-side bus 106. Memory I/O hub 104 provides the processor 102 with access to a variety of resources. Main memory 108 connects to memory I/O hub 104 over a memory or data bus. A graphics processor 110 also connects to memory I/O hub 104, allowing the graphics processor to communicate, e.g., with processor 102 and main memory 108. Graphics processor 110, in turn, provides display signals to a display device 112.

Other resources can also be coupled to the system through the memory I/O hub 104 using a data bus, including an optical drive 114 or other removable-media drive, one or more hard disk drives 116, one or more network interfaces 118, one or more Universal Serial Bus (USB) ports 120, and a super I/O controller 122 to provide access to user input devices 124, etc. The IHS 100 may also include a solid state drive (SSDs) 126 in place of, or in addition to main memory 108, the optical drive 114, and/or a hard disk drive 116. It is understood that any or all of the drive devices 114, 116, and 126 may be located locally with the IHS 100, located remotely from the IHS 100, and/or they may be virtual with respect to the IHS 100.

Not all IHSs 100 include each of the components shown in FIG. 1, and other components not shown may exist. Furthermore, some components shown as separate may exist in an integrated package or be integrated in a common integrated circuit with other components, for example, the processor 102 and the memory I/O hub 104 can be combined together. As can be appreciated, many systems are expandable, and include or can include a variety of components, including redundant or parallel resources.

In an embodiment, the present disclosure provides a work content variation control system to create rules that production control can use to schedule assembly processes for build-to-order products. One example is to use the work content variation control system of the present disclosure to plan assembly of IHSs by scheduling like systems/processes with like systems/processes on a given assembly line to create similar operation times (e.g., work content) at each of a plurality of work stations along an assembly line. In other words, if, for example, an IHS manufacturing facility has three assembly lines for assembling IHSs, the ordered IHSs that require assembly steps of similar duration in time may be assembled on the same one of the three assembly lines. Thus, the IHSs requiring the lowest operation times may be assembled on line 1, those requiring the highest operation times may be assembled on line 3 and those in between, may be assembled on line 2. As such, down-time at each station along the assembly line will be minimized to improve assembly line efficiencies and create an improved assembly product flow. A factor in determining scheduling may be at a platform level of an IHS family to reduce set-up for the assembly lines.

The work content variation control system of the present disclosure may be used to parse work content variation and create rules that production control can use to schedule manufacturing in an assembly line environment.

In an embodiment, the system may use historical data and/or market trends to receive order data and converts unique part numbers (PNs) to unique commodities (e.g., Hard Drives, Processors, etc.). Then, based on actual time studies (or estimates for new product platforms) the system assigns an install/assembly cycle time for each commodity at a given work station along the assembly line. At this point total work content may be calculated per system that is to be assembled. Then, based on total work content, the system may investigate what are the main commodities that drive work content cycle time variability within the platform/family. Once the commodities that drive variability are identified, the parsing rules are created and communicated to production control to schedule manufacturing for each available assembly line so that each line is assembling systems having similar work time at each operation station along the assembly line, thereby minimizing down time at any one station along the line.

It should be understood by a person having ordinary skill in the art that an embodiment of the present disclosure combines actual assembly cycle times per commodity with unique configurations to mathematically predict work content variation within a platform or product family. It should also be understood that an embodiment of the present disclosure provides a way for comparing each individual commodity versus total work content to determine which assembly processes are the main contributors to work content variation. In addition, it should be understood that an embodiment of the present disclosure provides parsing rules that are based on those commodities that drive total work content variation at a product platform level. In an embodiment, a visual system of analyzing a range of configurations within a platform is provided and thus, allows for filtering out the main commodities contributing to work content variation. In addition, once the parsing rules are setup in a factory planner/scheduling tool, the process may be automated. Using automation, minimal intervention is needed from production control.

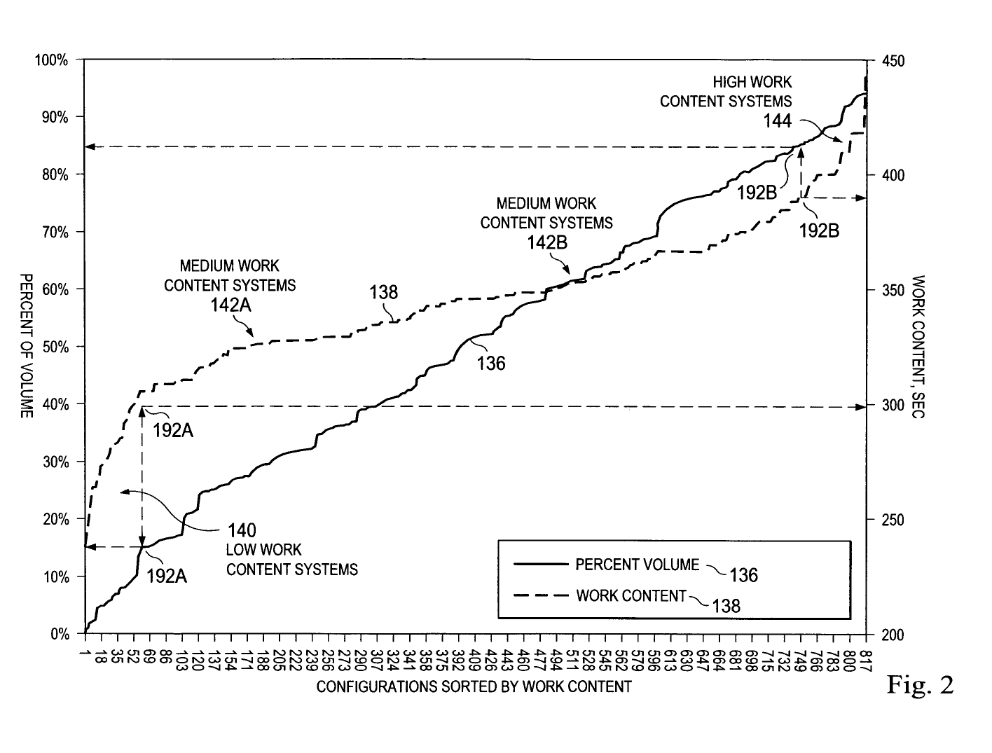

FIG. 2 illustrates an embodiment of a graph showing % of volume vs. configurations sorted by work content and work content time (e.g., in seconds) vs. configurations sorted by work content used in an embodiment of a work content variation control system. The % volume is shown as line 136. The work content is shown as line 138. Using a work content variation control system, a production control planner can improve efficiency of each of a plurality of assembly lines by scheduling work on the assembly line having a high efficient use of each assembly/work station on each assembly line. Using the graphical depiction of FIG. 2, a planner can schedule work for each assembly line based on the work content (e.g., amount of time) for each station along the assembly process for the IHS. In other words, IHSs ordered having a low work content for each assembly step are shown as low work content systems 140. IHSs ordered having a medium work content for each assembly step are shown as medium work content systems 142A and 142B. And, IHSs ordered having a high work content for each assembly step are shown as high work content systems 144. As should be understood, the system of FIG. 2 could support 4 assembly lines (e.g., 140, 142A, 142B and 144). However, any number of assembly lines and any number of work stations on each assembly line may utilize the systems and methods of the present disclosure.

FIG. 3 illustrates a high-level flow chart of an embodiment of a method 150 for work content variation control. The method 150 starts at 152 where orders have been received. In an embodiment, the orders may be for build-to-order IHSs, such as the IHS 100. However, the systems of the present disclosure may be utilized on assembly of any type of product. The method 150 then proceeds to block 154 where the method 150 pulls order data to determine family groupings of the orders. By grouping families of orders the method 150 may recognize families such as server IHSs, notebook IHSs, desktop IHSs, or even different product lines within each of these different types of IHSs. Other types of family groupings may be used. The method 150 then proceeds to block 156 where the method 150 reviews the orders, determines what parts or assemblies are required for each order and converts the order to a work content for a particular order. In other words, the method 150 determines how much time will be required to assemble the ordered IHS and how much time will be required at each assembly station for the particular order. The method 150 then proceeds to block 158 where the method groups similar work content orders by creating groups where the orders in each group have similar work content requirements as a whole, and/or in each work station along the assembly line. For example, the method 150 may group orders into groups for low work content systems 140, medium work content systems 142A, 142B and high work content systems 144, as seen in FIG. 1.

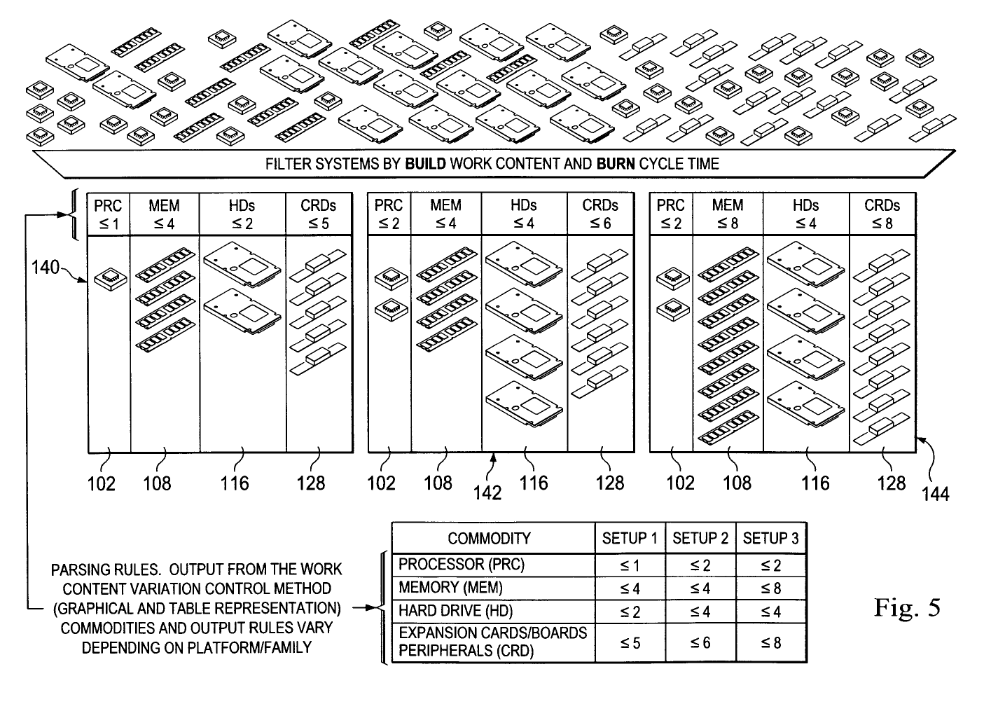

The method 150 then proceeds to block 160 where the method 150 creates parsing rules with respect to work content for the orders. As such, the method 150 creates rules to parse or break-up assembly of the ordered products (e.g., IHSs) into multiple work station operations along the assembly path. For example, assembly of an IHS may be parsed into groupings for adding parts to a chassis or a mother board. The added parts may include a number of processors 102, a number of memory modules 108, a number of hard drives 116, a number of expansion cards/peripherals 128, such as the graphics processor 110, the I/O controller 122, and/or a variety of other devices. The method 150 then proceeds to block 162 where the method defines set-up rules for an IHS (e.g., IHS 100) to use to schedule assembly of a plurality of orders along a plurality of assembly lines using the rules parsed in block 160. The rules may be defined by features such as a volume/number limits for parts to be added. For example, a rule may be that an order requiring ≦1 processors 102, ≦4 memory modules 108, ≦2 hard disk drives 116 and ≦5 expansion cards 128 are scheduled to be assembled on the assembly line for low work content systems 140. See FIG. 5. In another example, a rule may be that an order requiring ≦2 processors 102, ≦4 memory modules 108, ≦4 hard disk drives 116 and ≦6 expansion cards 128 are scheduled to be assembled on the assembly line for medium work content systems 142. See FIG. 5. In yet another example, a rule may be that an order requiring ≦2 processors 102, ≦8 memory modules 108, ≦4 hard disk drives 116 and ≦8 expansion cards 128 are scheduled to be assembled on the assembly line for high work content systems 144. See FIG. 5. It is to be understood that other factors may be used to create the rules and other values may be used to create the rules.

The method 150 then proceeds from block 162 to block 164 where the method 150 communicates the rules defined in block 162 to a scheduling IHS, such as the IHS 100, so that the scheduling IHS may calculate an assembly schedule. The calculated assembly schedule may then be communicated to a production control group for setting-up the manufacturing/assembly of the ordered products along the respective assembly lines per the schedule and the products may then be assembled. The method then ends at block 166.

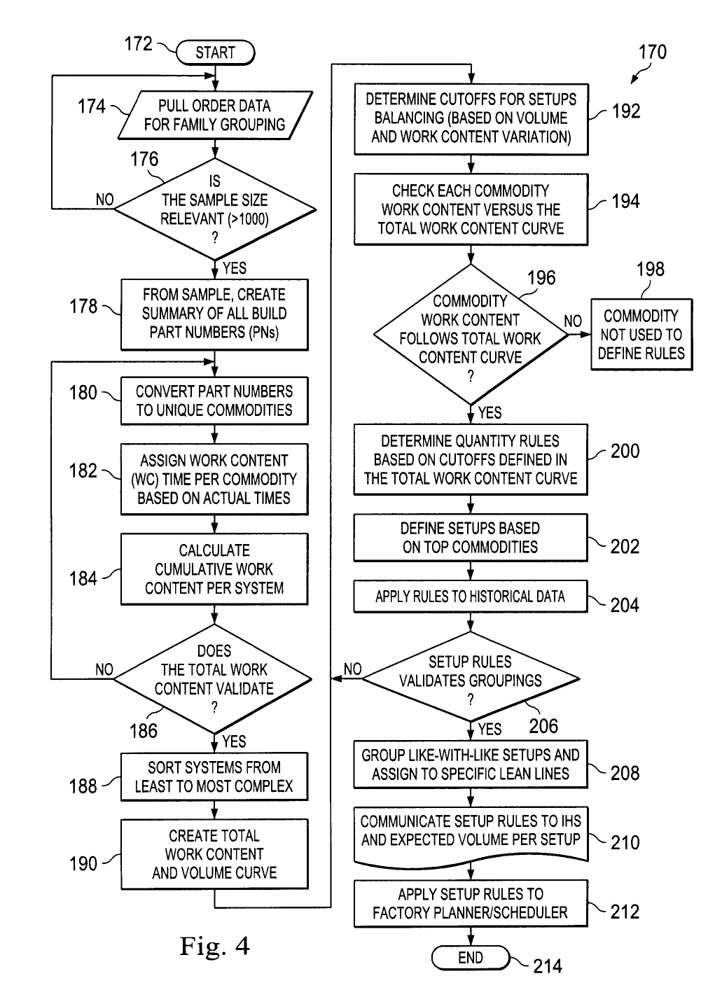

FIG. 4 illustrates a detailed flow chart of an embodiment of a method 170 for work content variation control. The method 170 is similar to method 150 described above with respect to FIG. 3. The method 170 starts at 172 where orders have been received. In an embodiment, the orders may be for build-to-order IHSs, such as the IHS 100. However, the systems of the present disclosure may be utilized on assembly of any type of product. The method 170 then proceeds to block 174 where the method 170 pulls order data to determine family groupings of the orders. By grouping families of orders the method 170 may recognize families such as server IHSs, notebook IHSs, desktop IHSs, or even different product lines within each of these different types of IHSs. Other types of family groupings may be used. Next, the method 170 proceeds to decision block 176 to determine whether a sample size is relevant to allow for accurate validation. In an embodiment, a sample size may be relevant if it includes more than 1000 samples. However, it is to be understood that any number of samples may be used. If no, the number of samples is not relevant, the method 170 returns to block 174. If yes, the number of samples is relevant, the method 170 proceeds to block 178 where the method 170 creates a summary of all build part numbers from the sample. The build part numbers may be the part numbers for the parts used to assemble the ordered products. The method 170 then proceeds to block 180 where the method 170 converts the build part numbers to unique commodities. The method 170 then proceeds to block 182 where the method 170 assigns work content time (e.g., the amount of time for a given operation) per commodity, where the assigned time is based on actual historical recorded times for similar work. The method 170 then proceeds to block 184 where the method 170 calculates a cumulative work content value for each of the ordered products. This calculated value may include a sum of the work content values (e.g., work times) for each step in an assembly process for each of the ordered products.

After calculating the cumulative work content per system at block 184, the method 170 then proceeds to decision block 186 where the method determines whether the calculated work content is validated by being similar to work content values for similar products previously assembled. If no, the calculated work content is not validated, the method 170 returns to block 180. However, if yes, the calculated work content is validated, the method 170 proceeds to block 188 where the method 170 sorts the ordered products/systems from least complex (e.g., least added parts) to most complex (e.g., most added parts). The method 170 then proceeds to block 190 where the method creates a total work content 138 and volume curve 136, such as that shown in FIG. 2. The method 170 then proceeds to block 192 where the method 170 determines cutoff points 192A and 192B along the curves (e.g., 136, 138). The method 170 then proceeds to block 194 where the method 170 checks each commodity work content versus the total work content curve.

After the method 170 checks each commodity work content versus the total work content curve at block 194, the method 170 then proceeds to decision block 196 to determine whether commodity work content follows the total work content curve. If no, the commodity work content does not follow the total work curve, the method 170 proceeds to block 198 where the method 170 does not use the commodity to define the rules. On the other hand, if yes, the commodity work contend does follow the total work curve, the method 170 proceeds to block 200 where the method 170 determines quantity rules based on cutoffs defined in the total work content curve (e.g., work content curve 138). The quantity rules may relate to a quantity of parts needed to complete assembly of the ordered products. The method 170 then proceeds to block 202 where the method 170 defines setups for the assembly process based on top or most common commodities. The method 170 then proceeds to block 204 where the method 170 applies the rules to historical data from similarly produced products.

After the method 170 applies the rules to historical data from similarly produced products at block 204, the method 170 proceeds to decision block 206 to determine whether the setup rules validate the projected order groupings. If no, the setup rules do not validate the projected order groupings, the method 170 returns to block 192. On the other hand, if yes, the setup rules do validate the projected order groupings, the method 170 proceeds to block 208 where the method 170 groups like-with-like setups and assigns these to specific assembly lines. As such, the assigned ordered products should be assigned to assembly lines where each of the different ordered products has similar assembly times or work content for similar work activities at each work station along the assembly line. The method 170 then proceeds to block 210 where the method 170 communicates the setup rules to a scheduling IHS, such as the IHS 100. Next, the method 170 proceeds to block 212 where the method 170 applies the setup rules to a factory planner/scheduler system. After applying the setup rules to a factory planner/scheduler system, the method 170 ends at block 214.

FIG. 5 a illustrates a chart showing embodiments of different parsing rules for use in the methods provided in FIGS. 3 and 4. As discussed above, the rules may be defined by features such as a volume/number limits for parts to be added. For example, a rule may be that an order requiring ≦1 processors 102, ≦4 memory modules 108, ≦2 hard disk drives 116 and ≦5 expansion cards 128 are scheduled to be assembled on the assembly line for low work content systems 140. In another example, a rule may be that an order requiring ≦2 processors 102, ≦4 memory modules 108, ≦4 hard disk drives 116 and ≦6 expansion cards 128 are scheduled to be assembled on the assembly line for medium work content systems 142. In yet another example, a rule may be that an order requiring ≦2 processors 102, ≦8 memory modules 108, ≦4 hard disk drives 116 and ≦8 expansion cards 128 are scheduled to be assembled on the assembly line for high work content systems 144. It is to be understood that other factors may be used to create the rules and other values may be used to create the rules. In an embodiment, parsing rules may vary depending on platform/family of the ordered products. Also, the rules may relate to actual product outputs as well as expected outputs. Additional features that may factor in to the rules may include software burn-in rate, traditional failure rate, custom factory integration, total work volume, highest work content, number of work stations along the assembly line, units produced per hour, number of parts in the ordered product, type of parts in the ordered product (e.g., type of chassis, and etc.), number of parts used daily, combined units per hour, labeling/packaging, order fulfillment system/factory planner used for scheduling and/or any variety of other factors.

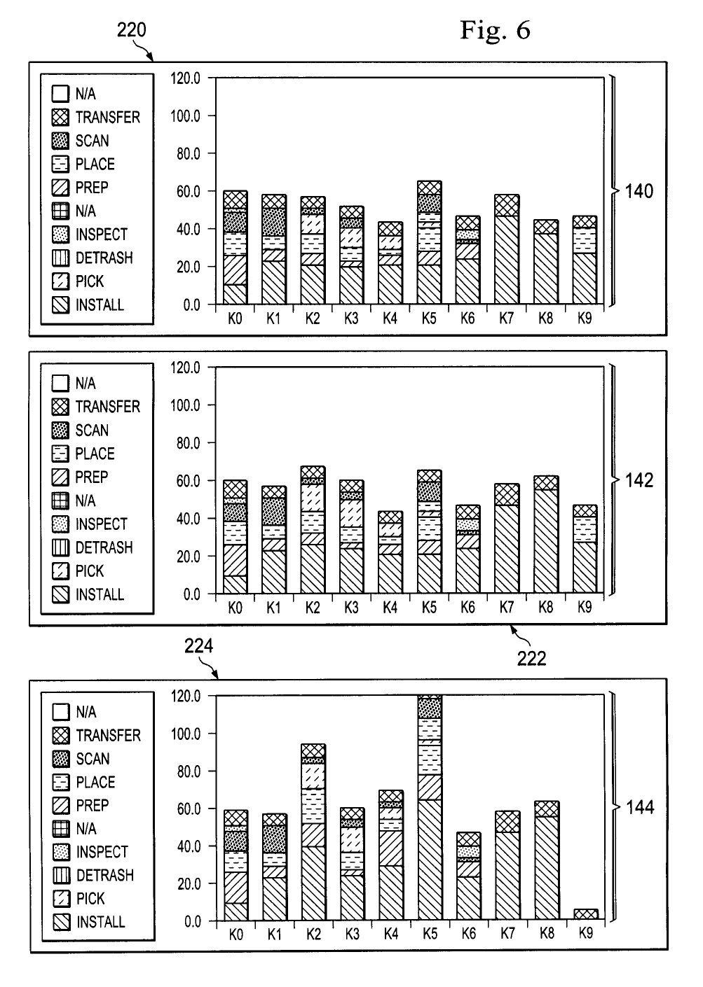

FIG. 6 illustrates embodiment of three balanced bar charts 220, 222, 224 showing work content at each of a number of work stations along an assembly line. The steps at each work station K0-K9 may be value added (e.g., install part) or non-value added (e.g., rotate system in conveyer). These charts 220, 222, 224 show an output for methods 150 and/or 170 after the rules have been created, applied and the work content balanced based on total work content, sequence restrictions and a number of work stations (e.g., K0-K9). The X-axis represents each work station (e.g., K0-K9) in a progressive assembly line. Any number of stations may be used with the present disclosure. The Y-axis represents the total work content (e.g., in seconds) for each station. The charts 220, 222, 224 show the work balance per station and as the rules change the balance per station changes due to more or less work content. As should be understood, chart 220 represents the steps of work content for workstations K0-K9 along an assembly line (e.g., low work content systems 140) where the work is scheduled using a variation control system of the present disclosure. chart 222 represents the steps of work content for workstations K0-K9 along an assembly line (e.g., low work content systems 142) where the work is scheduled using a variation control system of the present disclosure. chart 224 represents the steps of work content for workstations K0-K9 along an assembly line (e.g., low work content systems 144) where the work is scheduled using a variation control system of the present disclosure. It should also be understood that the charts 220, 222, 224 will change with each variation in ordered product as worked through methods 150 and/or 170.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. An apparatus comprising a computer-readable medium encoded with a computer program that, when executed:
receives order data for a family grouping of a plurality of ordered products;
converts the order data to work content;
groups the order data with like order data with respect to the work content;
creates parsing rules with respect to the work content; and
defines setup rules for use to schedule assembly of the ordered products.

2. The apparatus of claim 1, wherein the ordered products are IHSs.

3. The apparatus of claim 2, wherein the parsing rules consider a number of processors, a number of memory modules, a number of hard disk drives and/or a number of expansion cards ordered for the ordered IHSs.

4. The apparatus of claim 1, wherein the computer program validates the rules using historical assembly time data.

5. The apparatus of claim 1, wherein the computer program combines historical assembly cycle times for a given commodity with unique configurations to mathematically predict work content variation within the family grouping.

6. The apparatus of claim 1, wherein the computer program compares an individual commodity versus a total work content to determine contributing factors for work content variation and creates the parsing rules based on commodities that contribute to factors for work content variation.

7. The apparatus of claim 1, wherein the computer program schedules assembly of the ordered products based on the setup rules.

8. A scheduling information handling system (IHS) comprising:
a processor;
memory coupled with the processor; and
a computer-readable medium encoded with a computer program that, when executed:
receives order data for a family grouping of a plurality of build-to-order products;
converts the order data to work content;
groups the order data with like order data with respect to the work content;
creates parsing rules with respect to the work content; and
defines setup rules for use to schedule assembly of the build-to-order products.

9. The IHS of claim 8, wherein the build-to-order products are build-to-order IHSs.

10. The IHS of claim 9, wherein the parsing rules consider a number of processors, a number of memory modules, a number of hard disk drives and/or a number of expansion cards ordered for the build-to-order IHSs.

11. The IHS of claim 8, wherein the computer program validates the rules using historical assembly time data.

12. The IHS of claim 8, wherein the computer program combines historical assembly cycle times for a given commodity with unique configurations to mathematically predict work content variation within the family grouping.

13. The IHS of claim 8, wherein the computer program compares an individual commodity versus a total work content to determine contributing factors for work content variation and creates the parsing rules based on commodities that contribute to factors for work content variation.

14. The IHS of claim 8, wherein the computer program schedules assembly of the build-to-order products based on the setup rules.

15. A method of scheduling assembly of build-to-order information handling systems (IHSs), the method comprising:
receiving order data for a family grouping of a plurality of the build-to-order IHSs;
converting the order data to work content;
grouping the order data with like order data with respect to the work content;
creating parsing rules with respect to the work content; and
defining setup rules for use to schedule assembly of the build-to-order IHSs.

16. The method of claim 15, wherein the parsing rules consider a number of processors, a number of memory modules, a number of hard disk drives and/or a number of expansion cards ordered for the build-to-order IHSs.

17. The method of claim 15, wherein the method validates the rules using historical assembly time data.

18. The method of claim 15, wherein the method combines historical assembly cycle times for a given commodity with unique configurations to mathematically predict work content variation within the family grouping.

19. The method of claim 15, wherein the method compares an individual commodity versus a total work content to determine contributing factors for work content variation and creates the parsing rules based on commodities that contribute to factors for work content variation.

20. The method of claim 15, further comprising:
scheduling assembly of the build-to order IHSs based on the setup rules.
